(19) United States
(12) Patent Application Publication
(10) Pub. No.: US 2026/0320993 A1
(43) Pub. Date: Oct. 15, 2026

(54) Method and system for training an artificial intelligence and for generating an image

(71) Applicants: Friedrich-Alexander-Universität Erlangen-Nürnberg, in Vertretung des Freistaates Bayern, Erlangen (DE); Rohde & Schwarz GmbH & Co. KG, Munich (DE)

(72) Inventors: Martin VOSSIEK, Fürth (DE); Marcel HOFFMANN, Zirndorf (DE); Ingrid ULLMANN, Erlangen (DE); Christian EVERS, Heimstetten (DE)

(21) Appl. No.: 19/545,046

(22) Filed: Feb. 20, 2026

(30) Foreign Application Priority Data
Apr. 11, 2025 (DE) 102025114461.3

(51) Int. Cl. G06V 10/82; G06T 15/06

(52) U.S. Cl. CPC G06V 10/82; G06T 15/06

(57) ABSTRACT

The present invention relates to a computer-implemented training method for training an artificial intelligence, in particular an artificial neural network, which is configured to be used to determine an image of an object from real, in particular microwave tomographic, measurement data, having the steps of:
generating a physical model, wherein the physical model is generated at least partially using measurement data generated by an imaging modality and/or existing measurement data;
generating virtual and/or real, in particular microwave tomographic, measurement data using the physical model;
generating ground truth data, wherein the ground truth data is generated at least partially using the measurement data generated by an imaging modality and/or the existing measurement data;
training the artificial intelligence with the ground truth data and the virtual and/or real, in particular microwave tomographic, measurement data.

### FIELD

The present invention relates to a computer-implemented training method for training an artificial intelligence, in particular an artificial neural network, which is configured to be used to determine an image of an object from real, in particular microwave tomographic, measurement data.

### BACKGROUND

The use of microwaves for the diagnostic imaging of body structures of living beings is known from the prior art.

Systems for the diagnostic imaging of body structures of living beings using microwaves are, for example, radar systems. Such radar systems generally use aperture synthesis methods, in which an image of the respective body structure, in particular tissue structure, is determined from a set of measurement data via a computational reconstruction step.

Aperture synthesis methods are also used in radiation tomography, which is also referred to as conventional tomography or “ray tomography”, in diffraction tomography, which is referred to as “diffraction tomography”, in holographic methods or in “synthetic aperture radar” (SAR) methods. All of these methods are related; they all use a reconstruction step, which is carried out, for example, in a computer in order to determine the image of a body structure, in particular tissue structure.

The abovementioned methods can be summarized under the term microwave tomography.

Advantages of microwave tomography as a diagnostic imaging method are that microwaves, unlike, for example, X-ray radiation, are not ionizing and are therefore classified as having little to no adverse health effects, and therefore regular or even continuous screening is made possible or would be harmless to health. In addition, the use of microwave tomography in comparison with magnetic resonance tomography is much less time-consuming, less expensive, and less stressful for the patient.

Microwave tomography is particularly favored in the field of breast cancer diagnostics, since the abovementioned advantages are particularly relevant here.

A comprehensive overview of this can be found, for example, in the following publications:
“Al-Sawaftah, Nour, et al. “Microwave imaging for early breast cancer detection: Current state, challenges, and future directions.” Journal of Imaging 8.5(2022 ): 123”
“G. Peronnet et al., “A Microwave Diffraction Tomography System for Biomedical Applications,” 1983 13th European Microwave Conference, Nuremberg, Germany, 1983, pp. 529-533, doi: 10.1109/EUMA.1983.333285”
“Brian M. Moloney, Peter F. McAnena, Sami M. Abd Elwahab, Angie Fasoula, Luc Duchesne, Julio D. Gil Cano, Catherine Glynn, AnnaMarie O'Connell, Rachel Ennis, Aoife J. Lowery, Michael J. Kerin, “Microwave Imaging in Breast Cancer—Results from the First-In-Human Clinical Investigation of the Wavelia System,” Academic Radiology, vol 29, Supplement 1, 2022, pp. S211-S222, https://doi.org/10.1016/j.acra.2021.06.012”

However, microwave tomography is also used for other diagnostic purposes, for example for imaging joints, artificial joints, for detecting strokes, for imaging heart muscle tissue, for detecting infarcts, for diagnosing burn wounds and for much more, as can be seen by way of example from the following publications:
“Tournier, Pierre-Henri, et al. “Numerical modeling and high-speed parallel computing: New perspectives on tomographic microwave imaging for brain stroke detection and monitoring.” IEEE Antennas and Propagation Magazine 59.5(2017 ): 98-110”
“Serguei Semenov et al, “Microwave tomography for functional imaging of extremity soft tissues: feasibility assessment,” Sept. 2007 Physics in Medicine & Biology, vol 52, no. 18, DOI 10.1088/0031-9155/52/18/015”

Imaging methods by means of microwave tomography or microwave tomographic imaging methods are usually performed according to the prior art in such a way that
a) an object is illuminated with a microwave signal, preferably from a plurality of directions, i.e., preferably with at least one microwave transmitter from preferably a plurality of directions;
b) the wave field transmitted through the object or the wave field scattered back by the object is detected by at least one but preferably a plurality of spatially distributed receivers;
c) a reconstruction algorithm is used to invert the wave propagation processes, i.e., the attenuation, diffraction and/or scattering processes occurring in the tissue, in order to thus infer the material parameters or at least the material parameter differences and their spatial distribution from the detected wave field, in order to generate an image of the object in this way.

A challenge in diagnostic imaging methods is that biological tissues are generally inhomogeneous media, making the inversion problem non-linear and very difficult to solve. Biological tissues generally have a large number of scattering bodies and inhomogeneities. The assumption of weak scattering processes, also known as Born's approximation, which is usually used for the linearization of scattering and/or imaging problems, is only valid to a limited extent here. If Born's approximation should be approximately applicable, the problem arises that the exact dielectric properties of the tissue are unknown, since these can vary greatly from living being to living being and depending on the state of the living being, and therefore at best average dielectric properties and/or also other material properties, such as, for example, the roughness of surfaces and/or the shape or the course of boundary surfaces that influence the reflection behavior, can be known in advance in a very rough approximation. The wave propagation speeds as well as diffraction and refraction effects can therefore not be correctly modeled or inverted. Another problem is that biological materials are highly dispersive. The dispersive properties, too, can vary greatly from tissue type to tissue type and from living being to living being and depending on the condition of the respective living being.

The description and inversion of wave propagation processes in biological materials is extremely complicated using methods known from the prior art. The vast majority of known imaging methods are therefore based on Born's approximation or similar linearization approaches. In these approaches, too, the estimation of the a priori unknown wave propagation speeds is very challenging and not conclusively solved. Non-linear inversion and qualitatively optimal imaging using wave-based sensor systems is therefore generally very difficult to implement with the known or conventional approaches in the field of diagnostic imaging methods and has not yet been conclusively solved.

One conceivable approach to solving the aforementioned challenges is to tackle non-linear inversion or diagnostic wave-based imaging based on machine learning methods or artificial intelligence.

In principle, machine learning methods are able to perform the necessary non-linear inversion and also to solve multidimensional estimation problems.

It is also known that a so-called “superresolution”, i.e., a resolution better than the Fourier limits determined by the wavelength, can be achieved with machine learning methods. The latter would be very advantageous for microwave tomography, as the attenuation properties of biological tissue mean that frequencies below 10 GHz, i.e., signals with a rather large wavelength, are preferably used here, which greatly limits the achievable resolution of conventional microwave tomographic imaging methods.

However, the efficient implementation of this very promising signal processing approach with machine learning methods has so far often failed due to the lack of suitable training for the machine learning methods.

### SUMMARY

In particular, the generation of ground truth data for training the machine learning method is extremely complex or often even impossible according to the prior art.

To generate ground truth data or training data sets, prior art requires that an imaging method other than a microwave tomographic imaging method is performed simultaneously with or at least immediately after a microwave tomographic imaging method.

In order for the ground truth data to have a quasi-perfect image of the body area to be imaged, the other imaging method is preferably an imaging method that has an imaging quality that corresponds at least to the desired imaging quality of the microwave tomographic imaging method—but preferably it should be significantly better in order to expect good training results.

Considering the prior art, it is only conceivable with very great effort or not at all that, for example, measurements are performed simultaneously with a microwave tomographic and another imaging method over hundreds or thousands of test subjects, if necessary over several years, in the full knowledge that the microwave tomographic measurements initially provide hardly any diagnostic added value. The diagnostic added value of the microwave tomographic imaging method only becomes apparent once the machine learning method has been sufficiently trained.

Against this background, the present invention is based on the task of mitigating or even completely eliminating the disadvantages of the prior art and, in particular, a method for training an artificial intelligence, which is configured to be used to determine an image of an object from real, microwave tomographic measurement data.

This task is solved by the method having the features of independent claim 1. Advantageous developments of the invention are the subject matter of the dependent claims.

Accordingly, the invention provides for: A computer-implemented training method for training an artificial intelligence, in particular an artificial neural network, which is configured to be used to determine an image of an object from real, in particular microwave tomographic, measurement data, having the steps of:
generating a physical model, wherein the physical model is generated at least partially using measurement data generated by an imaging modality and/or existing measurement data;
generating virtual and/or real, in particular microwave tomographic, measurement data using the physical model;
generating ground truth data, wherein the ground truth data is generated at least partially using the measurement data generated by an imaging modality and/or the existing measurement data;
training the artificial intelligence with the ground truth data and the virtual and/or real, in particular microwave tomographic, measurement data.

The artificial intelligence preferably uses “deep learning” or machine learning and/or is preferably an artificial neural network or a convolutional network, for example a “convolutional neural network” (CNN).

Preferably, the artificial intelligence is trained by entering or presenting to it as much and as varied as possible measurement data and the associated ground truth data at the same time and/or by successively training the same in such a way that the artificial intelligence processes the measurement data in such a way that the processing result corresponds at least partially to the ground truth data.

The use of the imaging modality in generating ground truth data is preferably accomplished at least in part by generating measurement data and/or image data through the imaging modality.

Preferably, the measurement data can comprise, for example, image data.

The ground truth data can comprise or be, for example, an image, in particular a perfect image, of an area of the body to be imaged and/or an annotated diagnostic evaluation result, which could, for example, be that an area of the body detected by microwave tomography has a tumor or other pathology.

Preferably, it is provided that the trained artificial intelligence is able to reconstruct the ground truth data from the real microwave tomographic measurement data and/or that the artificial intelligence has learned, for example, in particular during training, a non-linear inversion and/or that, for example, tissue structures in the body of living beings can now be imaged and/or diagnoses for any pathologies can be made, even if the tissue structure is inhomogeneous and/or the material parameters are not known in advance.

The ground truth data and/or the virtual and/or real microwave tomographic measurement data can also be referred to as training data or training data set.

Preferably, it is provided that the measurement data generated by the imaging modality and/or existing measurement data is or was generated by a plurality of imaging modalities of the same type.

Preferably, it is provided that the imaging modality is one or no microwave tomograph, a magnetic resonance tomograph, a computer tomograph, a sonograph or an X-ray apparatus.

Preferably, the imaging modality generates measurement data of the imaging modality using an imaging method. The imaging method is preferably an established and powerful diagnostic method, which can be referred to as gold standard method, for example.

The microwave tomography is particularly favored for breast cancer diagnostics or mammary diagnostics.

Preferably, it is provided that, when generating the physical model, one or more material or surface conditions are recorded, in particular those that influence the reflection behavior at the interface, and/or a permittivity and/or a spatial permittivity distribution of at least one area of the physical model is determined by means of a transformation from measurement data generated by the imaging modality and/or existing measurement data. The roughness of surfaces and/or the shape or the course of boundary surfaces are to be mentioned as an example for such material conditions.

Preferably, it is provided that the transformation is performed using a further artificial intelligence, in particular a generative neural network.

Preferably, it is provided that the physical model is a simulation model or a real phantom model and/or a plurality of physical models is used when generating virtual and/or real, in particular microwave tomographic, measurement data.

The virtual microwave tomographic measurement data is preferably generated using a simulation model as a physical model and the real microwave tomographic measurement data is preferably generated using a phantom model as a physical model.

Preferably, it is provided that generating the virtual, in particular microwave tomographic, measurement data is performed using simulation software, which preferably uses a full-wave simulation and/or a ray tracing simulation.

Preferably, it is provided that the ground truth data is generated at least partially using medical diagnoses and/or human evaluations and/or comprises the physical model and/or the measurement data generated by the imaging modality and/or the existing measurement data.

Preferably, it is provided that the ground truth data comprises or is diagnostically annotated training data.

The invention also relates to a computer-implemented imaging method for generating an image of an object using an artificial intelligence, in particular an artificial neural network, which is trained in particular by means of a training method of the invention, having the steps of:
performing a detection, in particular a microwave tomography, of at least a part of the object or of the entire object, whereby a generation of real, in particular microwave tomographic, measurement data is performed;
generating an image of the object from the real, in particular microwave tomographic, measurement data by means of the artificial intelligence.

The real microwave tomographic measurement data is preferably generated in a microwave tomography for generating an image of an object, i.e., in particular not as part of the training of the artificial intelligence.

Preferably, it is provided that the object is a living being, in particular a human being and/or a female breast, or an inanimate object, in particular an antique and/or archaeological object, a rock formation or a component.

The invention also relates to a system having means, which comprise in particular an artificial intelligence unit, which are configured to perform a training method of the invention and/or an imaging method of the invention.

In other words, a training method for generating training data for implementing an improved evaluation of microwave tomographic measurement data and an improved measurement arrangement having neural networks, for use in the field of diagnostic detection, imaging or analysis of the body's inner structures is preferably performed.

At this point, it should be noted that the terms “a” and “an” do not necessarily refer to exactly one of the elements, although this represents a possible embodiment, but can also denote a plurality of the elements. Likewise, the use of the plural also includes the presence of the element in question in the singular and, conversely, the singular also comprises a plurality of the elements in question. Furthermore, all features of the invention described herein can be combined with one another as desired or claimed in isolation from one another.

### BRIEF DESCRIPTION OF DRAWING

FIG. 1 shows a flowchart or a processing chain of an exemplary embodiment.

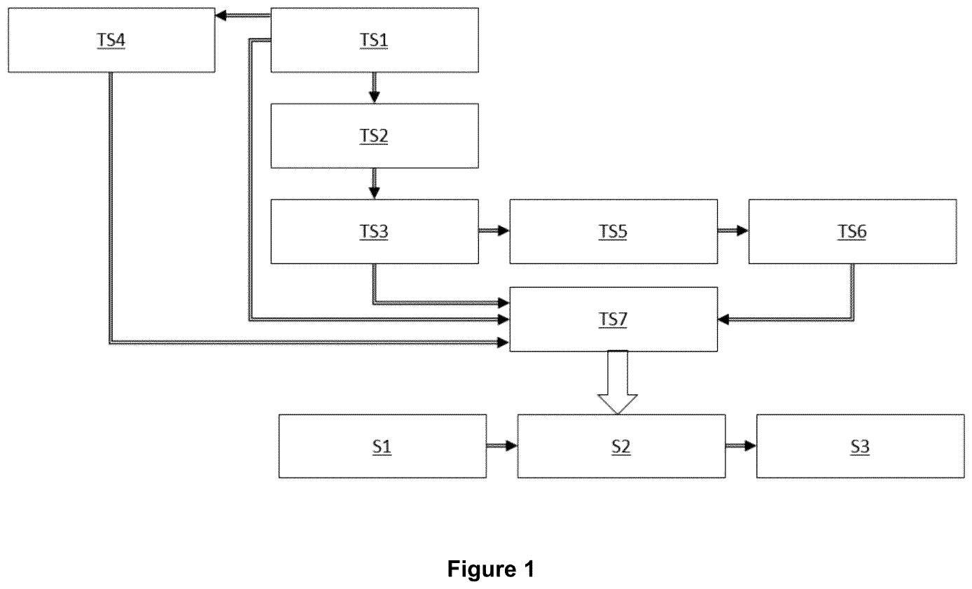

### DETAILED DESCRIPTION

Further advantages, features and effects of the present invention result from the following description of preferred embodiments, in particular with reference to the figure, in which identical or similar components are denoted by the same reference numerals.

In this case, the only figure shows a flowchart or a processing chain of an exemplary embodiment of a method according to the invention.

In the figure, real microwave tomographic measurement data are generated in step S1 by a microwave tomograph of an object, which in this example is a female breast or breast tissue.

These real microwave tomographic measurement data are entered in step S2 into a trained artificial neural network and processed in such a way that in step S3 an image of the object, i.e., in the example a three-dimensional image of the female breast or of the breast tissue and/or a diagnostic result, i.e., in this example a finding as to whether a tumor or whether breast cancer is present in the female breast or the breast tissue, are generated by the trained artificial neural network.

The trained artificial network is generated in a method for training an artificial neural network from an artificial neural network to be trained, i.e., an untrained or pre-trained artificial neural network.

For this purpose, measurement data comprising an image of an object, in particular a plurality of objects, i.e., in this example a plurality of female breasts, is generated in step TS1 by an, in particular diagnostic, imaging modality, which is preferably not a microwave tomograph but in this example a computer tomograph. This measurement data can also be generated by different imaging modalities of the computer tomograph type.

Using the measurement data generated by the imaging modality, a physical model, which has a spatial permittivity distribution, of the object or a plurality of these physical models are generated in steps TS2 and TS3 by a transformation, which can be performed on the basis of literature data and/or by means of a generative artificial neural network.

In step TS4, the measurement data generated by the imaging modality is medically diagnosed or a medical diagnosis is already available for this measurement data.

The measurement data generated by the imaging modality can thus be a data set of many different imaging modalities by type of imaging modality and the medical diagnoses associated with each. The medical diagnoses can each also have a diagnosis result or a finding, diagnosis features and/or one or more diagnostically and/or physiologically segmented images.

The measurement data generated by the imaging modality, the physical model or the physical models and/or the medical diagnoses are each ground truth data, in particular for training the artificial neural network to be trained.

In steps TS5 and TS6, virtual microwave tomographic measurement data is generated by means of the physical model or the physical models and a simulation software or a simulation tool, e.g. by means of a full-wave simulation and/or a ray tracing simulation. Steps TS5 and TS6 can be run through once or multiple times for each physical model.

In step TS7, the artificial neural network to be trained is trained with the ground truth data and the virtual microwave tomographic measurement data. The virtual microwave tomographic measurement data is therefore part of the training data.

In other words, a method for generating training data for training neural networks for evaluating real microwave tomographic measurement data is preferably provided. The network trained in this way is preferably the basis of a method for improved diagnostics of tissue pathologies and in particular for improved diagnostics of tumor-related tissue changes based on microwave tomography.

The method for generating training data preferably uses a large number of simulation models or of real phantom models that represent the material structure of the body area to be examined reasonably correctly, at least in the statistical manifold, for generating virtual and/or real microwave tomographic measurement data. “Virtual” preferably means that the measurement data is not obtained from living beings, but from simulation models or simulations. “Real” preferably means that the measurement data is not obtained from living beings, but from phantom models.

Preferably, a large number of sufficiently realistic simulation models or phantom models is generated. The term “physical model” can be used as a standardized collective term for such sufficiently realistic simulation models or phantom models.

An exemplary phantom model is an artificially produced breast phantom, i.e., a real representation model of a female breast.

In principle, the generation of such physical models is extremely complex and no practicable methods are yet known. The reason for this is that the spatial tissue parameter distribution in living beings is not directly accessible from the outside and it would only be possible to detect the tissue parameter distribution using microwave tomography once the non-linear inverse problem had been solved. In order to overcome this “chicken and egg problem”, it is preferable to use another imaging modality, such as magnetic resonance tomography, computer tomography, or ultrasound diagnostics, as the basis for deriving such physical models.

In microwave tomographic imaging, the permittivity, conductivity, and/or their geometric distribution are preferably relevant as tissue material parameters. For the other imaging modalities, other material parameters are actually relevant. In the case of ultrasound, these are the density and/or the compressibility, in the case of X-rays the absorption coefficient or density values in Hounsfield units, in the case of MRT, for example, the proton density or the T1 or T2 relaxation times.

At frequencies above a few 10 MHz, the ohmic conductivity is significantly less relevant than the permittivity for the propagation of microwaves in biological tissue. The imaginary part of the permittivity is often also referred to in the literature as dielectric conductivity. The permittivity of biological tissue is very strongly determined by its water content or by the blood flow. Thus, for instance, adipose tissue has a significantly lower permittivity than muscle tissue with a good blood supply, which results in the contrast, i.e., the distinguishability, of different materials. It is known that carcinogenic tissue generally has a different tissue structure and a different blood supply than the surrounding tissue and can therefore be detected by microwave tomography.

The large scattering of permittivity and conductivity in body tissue, which is caused by the anisotropy of the body tissue, for example, due to the fiber direction in muscle tissue, illustrates the complexity in the creation of suitable physical models.

The relevant material parameters of the aforementioned other imaging modalities have, for example, a strong dependence on the water and/or blood content of the body tissue. In general, these imaging modalities also make it possible to classify certain tissue types, e.g., fat, muscle, blood, liquor, glandular tissue, carcinomas, etc.

Preferably, it is provided to use the previously illustrated correlations of the different material parameters or the correlation of the different imaging contrasts of the aforementioned other imaging modalities to use images of one of the aforementioned other imaging modalities to derive a physical model that represents the spatial permittivity distribution of the object or the imaged area at least qualitatively correctly.

This transformation of the imaging contrasts of other imaging modalities into physical models of the spatial permittivity distribution can be performed in different ways.

One possibility is to proceed on the basis of literature data. For all the aforementioned imaging modalities, there have been many publications on which tissue type is depicted as in an image of the respective modality and how images can be segmented accordingly. On the other hand, extensive data and/or tables are available on the permittivity values of biological tissue types. The use of both pieces of information immediately provides an approach to performing the desired transformation.

As a further possibility of implementing the transformation, neural networks, in particular generative neural networks, are preferably used. Here, the transformation is learned in a training phase based on existing, e.g. manually annotated, measurement data, or using measurement data from known phantom models.

For example, magnetic resonance tomography images that were recorded with water-weighted (T2w) sequences are advantageous for the transformation. In these, it is possible to differentiate well between the tissue compartments, e.g., between glandular tissue, adipose tissue, and blood vessels. A further advantageous variant is MR-based Electrical Properties Tomography (EPT).

The great advantage of the approach according to the invention is that for many pathologies, e.g., breast cancer, large image data sets that were obtained with the other imaging modalities already exist worldwide. Through the proposed transformation, these data sets can be converted directly into large training data sets suitable for training neural networks for implementing an improved evaluation of real microwave tomographic measurement data.

After a physical model was derived by the transformation in a first step, virtual and/or real microwave tomographic measurement data is then preferably generated in a second step. This virtual and/or real microwave tomographic measurement data generated in this way forms at least part of the actual training data.

The physical models or the measurement data of the other imaging modalities are preferably part of the so-called “ground truth”.

The virtual and/or real microwave tomographic measurement data can be generated, for example, in the following two ways.

To generate real microwave tomographic measurement data, phantom models can be produced, in particular based on the derived physical models, the phantom models can be imaged with a microwave tomograph and the real microwave tomographic measurement data, in particular as training data, can thus be generated.

However, the Second Type Described Below Is Particularly Advantageous.

To generate virtual microwave tomographic measurement data, the derived physical models can be entered into a simulation tool which simulates the wave propagation in the tissue. For example, known full-wave simulators, e.g., HFSS, ANSYS, CST, or ray tracing approaches, as can be seen from the following publication, are suitable for this purpose:
“C. Schüßler, M. Hoffmann, J. Bräunig, I. Ullmann, R. Ebelt and M. Vossiek, “A Realistic Radar Ray Tracing Simulator for Large MIMO-Arrays in Automotive Environments”, IEEE Journal of Microwaves, pp. 1-13, 2021. DOI: 10.1109/JMW.2021.3104722”

The simulation software or the simulation tool is preferably to be configured such that it emulates a microwave tomographic measurement and in this way generates virtual microwave tomographic measurement data, which can then be used as training data.

The advantage of the second type, in addition to the significantly lower effort and the simple possibility of generating larger training data sets, is that data can be generated for different, and ultimately any number of, topologies of microwave tomographic imaging systems. The evaluation of the respective training success, i.e., the evaluation of the ability of the artificial neural network to generate the best possible image of the object or of the imaged region from real microwave tomographic measurement data or to enable the best possible diagnosis (which can be done directly by systematically comparing the evaluation result with the “ground truth”), makes it possible to find an optimal design of the microwave tomographic measurement system for a specific application as early as the design process, without having to actually built all conceivable or examined variants.

Preferably, it is provided that a microwave tomographic diagnostic imaging system is configured in such a way that it comprises a neural network which has been trained using the method described above. The task of the artificial neural network in the arrangement is to evaluate measured real microwave tomographic measurement data for the purpose of imaging, or for the purpose of detecting a pathology, or generally for the purpose of a medical diagnosis.

The invention can also be used in areas outside of medical diagnostics, e.g., in forensics, biology, archaeology, geology, or in non-destructive testing in a comparable manner.

The invention can also be applied to the field of ultrasound imaging.

In other words, a method for generating real microwave tomographic measurement data is preferably provided, wherein measurement data of another diagnostic imaging modality is used to form a physical model of a body region and this physical model is used to generate virtual and/or real microwave tomographic measurement data.

It is conceivable that the real microwave tomographic measurement data was obtained by measuring a phantom derived from the physical model.

It is conceivable that the virtual microwave tomographic measurement data is obtained by a simulation tool that uses the physical model.

It is conceivable that the virtual and/or real microwave tomographic measurement data is used to train a neural network or another machine learning method.

It is conceivable that the measurement data of the other diagnostic imaging modality, or the physical model of the imaged body region, is used to train the neural network or the other machine learning method in addition to the virtual and/or real microwave tomographic measurement data.

It is conceivable that the neural network trained in this way or the other machine learning method trained in this way is used to evaluate real or measured microwave tomographic measurement data.

It is conceivable that the neural network trained in this way or the other machine learning method trained in this way is used to evaluate real or measured microwave tomographic measurement data for the purpose of a diagnostic detection, imaging or analysis of the body's inner structures.

It is conceivable that the detection, imaging or analysis of the body's inner structures is used, in particular, to detect or image tumors or other diagnostically relevant tissue structures or tissue structure changes.

It is conceivable that the detection, imaging or analysis of the body's inner structures is used, in particular, to diagnose or image joint or bone structures.

It is conceivable to use a microwave tomographic imaging arrangement comprising a neural network which has been trained according to a method mentioned above.

1. A computer-implemented training method for training an artificial intelligence, in particular an artificial neural network, which is configured to be used to determine an image of an object from real, in particular microwave tomographic, measurement data, having the steps:
generating a physical model, wherein the physical model is generated at least partially using measurement data generated by an imaging modality and/or existing measurement data;
generating virtual and/or real, in particular microwave tomographic, measurement data using the physical model;
generating ground truth data, wherein the ground truth data is generated at least partially using the measurement data generated by an imaging modality and/or the existing measurement data;
training the artificial intelligence with the ground truth data and the virtual and/or real, in particular microwave tomographic, measurement data.

2. The training method of claim 1, characterized in that the imaging modality is one or no microwave tomograph, a magnetic resonance tomograph, a computer tomograph, a sonograph or an X-ray apparatus.

3. The training method of claim 1, characterized in that, when generating the physical model, a surface condition and/or a permittivity and/or a spatial permittivity distribution of at least one region of the physical model is determined by means of a transformation from measurement data generated by the imaging modality and/or existing measurement data.

4. The training method of claim 3, characterized in that the transformation is performed using a further artificial intelligence, in particular a generative neural network.

5. The training method of claim 1, characterized in that the physical model is a simulation model or a real phantom model and/or a plurality of physical models is used when generating virtual and/or real, in particular microwave tomographic, measurement data.

6. The training method of claim 1, characterized in that generating the virtual, in particular microwave tomographic, measurement data is performed using simulation software, which preferably uses a full-wave simulation and/or a ray tracing simulation.

7. The training method of claim 1, characterized in that the ground truth data is generated at least partially using medical diagnoses and/or human evaluations and/or comprises the physical model and/or the measurement data generated by the imaging modality and/or the existing measurement data.

8. A computer-implemented imaging method for generating an image of an object using an artificial intelligence, in particular an artificial neural network, which is trained in particular by means of a training method of claim 1, having the steps of:
performing a detection, in particular a microwave tomography, of at least a part of the object or of the entire object, whereby a generation of real, in particular microwave tomographic, measurement data is performed;
generating an image of the object from the real, in particular microwave tomographic, measurement data by means of the artificial intelligence.

9. The imaging method of claim 8, characterized in that the object is a living being, in particular a human being and/or a female breast, or an inanimate object, in particular an antique and/or archaeological object, a rock formation or a component.

10. A system having means, which comprise in particular an artificial intelligence unit, which are configured to perform a training method of claim 1 and/or an imaging method for generating an image of an object using an artificial intelligence, in particular an artificial neural network, which is trained in particular by means of a training method of claim 1, having the steps of:
performing a detection, in particular a microwave tomography, of at least a part of the object or of the entire object, whereby a generation of real, in particular microwave tomographic, measurement data is performed;
generating an image of the object from the real, in particular microwave tomographic, measurement data by means of the artificial intelligence.
